(19) United States
(12) Patent Application Publication
(10) Pub. No.: US 2025/0217938 A1
(43) Pub. Date: Jul. 3, 2025

(54) Weighting Functions and Adaptive Noise Schedule for Training Noise-Based Machine-Learned Models

(71) Applicant: Google LLC, Mountain View, CA (US)

(72) Inventors: Diederik Pieter Kingma, San Francisco, CA (US); Ruiqi Gao, San Francisco, CA (US)

(21) Appl. No.: 18/985,490

(22) Filed: Dec. 18, 2024

Related U.S. Application Data
(60) Provisional application No. 63/616,451, filed on Dec. 29, 2023.

(51) Int. Cl. G06T 5/60; G06T 5/73

(52) U.S. Cl. CPC G06T 5/60; G06T 5/73; G06T 2207/20081

(57) ABSTRACT

Weighting functions and adaptive noise distributions are provided for training a machine-learned model (e.g., image generation model) based on noised image data. A training image can be noised according to a noise distribution, which can be an adaptive noise distribution. A machine-learned model can process the noised training image to generate an output. A training system can update the machine-learned model based on a weighted loss, which can be based on the output and a weighting function. The weighting function can be monotonically non-increasing with respect to a signal-to-noise ratio. In some instances, the weighting function can have an approximately sigmoidal shape.

### CROSS-REFERENCE TO RELATED APPLICATIONS

The present application is based upon and claims the right of priority to U.S. Provisional Patent Application No. 63/616,451, filed on Dec. 29, 2023, the disclosure of which (including any appendices) is hereby incorporated by reference herein in its entirety for all purposes.

### FIELD

The present disclosure relates generally to machine learning processes and machine-learned devices and systems. More particularly, the present disclosure relates to weighting functions and adaptive noise schedules for training noise-based machine-learned models (e.g., diffusion models), including a class of weighting functions that unlocks the possibility of training non-diffusion models on a diffusion objective.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining a loss distribution over a range of noise levels, wherein the loss distribution describes loss magnitudes computed using outputs of a reference machine-learned image processing model when processing training images that were noised using the range of noise levels. The example method can include determining, based on the loss distribution, a noise distribution. The example method can include training, using a loss function, a subject machine-learned image processing model using noised training images that were noised using noise levels selected according to the noise distribution. In the example method, the noise distribution can be configured to decrease a variance of loss values generated by the loss function during training.

In the example method, the reference machine-learned image processing model can be the subject machine-learned image processing model. In the example method, the loss distribution can be obtained during training of the subject machine-learned image processing model.

In the example method, the loss distribution can comprise a plurality of respective aggregated values associated with a plurality of respective subranges of the range of noise levels.

In the example method, a respective aggregated value of the plurality of respective aggregated values can comprise an exponential moving average.

In the example method, determining the noise distribution can comprise determining, based on the plurality of respective aggregated values, a plurality of respective noise probabilities associated with the plurality of respective subranges, wherein a respective noise probability is proportional to a corresponding respective aggregated value.

In the example method, the loss function can be configured to have an expected value that is stable with respect to a change, other than a change to one or more endpoints, to the noise distribution.

Example aspects of the present disclosure provide another example method. In some implementations, the example method can include obtaining a respective training example. The example method can include noising the respective training example based on a noise distribution characterized by a range of noise levels. The example method can include processing the noised training example to generate a respective output. The example method can include updating the machine-learned model based on the respective output and a noise-weighted objective function. In the example method, the noise-weighted objective function can be characterized by a weighting function that is monotonically non-increasing with a measure of signal-to-noise ratio. In the example method, the weighting function can be characterized by a plateau having a first average slope over a first subrange of noise levels. In the example method, the weighting function can be characterized by a descent having a second average slope over a second subrange of noise levels. In the example method, the first subrange of noise levels can contain at least one noise level lower than at least one noise level of the second subrange. In the example method, the second average slope can be steeper than the first average slope.

In the example method, the weighting function can be characterized by a maximum weight over the range of noise levels. In the example method, at least one weight associated with a log-signal-to-noise ratio between −2.5 and 2.5 can be greater than or equal to 20 percent of the maximum weight.

In the example method, the weighting function can be characterized by a finite maximum weight over its natural domain.

In the example method, the weighting function can be characterized by an overall minimum weight and overall maximum weight over the range of noise levels. In the example method, the weighting function can be characterized by a subrange maximum weight and subrange minimum weight over the second subrange of noise levels. In the example method, a difference between the subrange maximum weight and the subrange minimum weight can be at least 70 percent of a difference between the overall maximum weight and the overall minimum weight.

In the example method, the weighting function can be characterized by one or more steepest points, wherein a slope of the weighting function at the steepest points is steeper than a slope of the weighting function at any other point within the range of noise levels. In the example method, the weighting function can be configured such that none of the steepest points is an endpoint of the range of noise levels.

In the example method, the weighting function can be characterized by one or more steepest points, wherein a slope of the weighting function at the steepest points is steeper than a slope of the weighting function at any other point. In the example method, at least one of the steepest points can be associated with a log-signal-to-noise ratio between 5.0 and −5.0.

In the example method, the weighting function can correspond to a noise weighting of an evidence lower bound.

In the example method, updating the machine-learned model can comprise optimizing the machine-learned model with respect to a monotonically noise-weighted evidence lower bound. In the example method, the machine-learned model can be a first machine-learned model. The example method can include optimizing a second machine-learned model with respect to the monotonically noise-weighted evidence lower bound. In the example method, the first machine-learned model can be a diffusion model. In the example method, the second machine-learned model can be a model that is not a diffusion model.

In the example method, the second machine-learned model can be a likelihood-based machine-learned model.

Example aspects of the present disclosure provide another example method. The example method can include obtaining a weight function search space. The example method can include optimizing a first machine-learned model with respect to a first objective comprising a first weight function iteratively selected from the weight function search space. The example method can include optimizing a second machine-learned model with respect to a second objective comprising a second weight function iteratively selected from the weight function search space. The example method can include comparing a performance of the first machine-learned model to a performance of the second machine-learned model.

In the example method, the weight function search space can include a parameterized function. In the example method, iteratively selecting a weight function from the weight function search space can include updating a parameter of the parameterized function.

The example method can include obtaining a loss distribution over a range of noise levels, wherein the loss distribution describes loss magnitudes computed using outputs of a reference machine-learned image processing model when processing training images that were noised using the range of noise levels. The example method can include determining, based on the loss distribution, a noise distribution. In the example method, optimizing the second machine-learned model can include training, using a loss function, the second machine-learned model using noised training images that were noised using noise levels selected according to the noise distribution. In the example method, the noise distribution can be configured to decrease a variance of loss values generated by the loss function during training.

In the example method, the first weight function can be a function of a noise level.

In the example method, the first objective can correspond to a monotonically noise-weighted evidence lower bound.

Example aspects of the present disclosure provide one or more example non-transitory computer-readable media storing instructions that are executable by one or more processors to cause a computing system to perform operations. The operations can include any one or more of the implementations of the example methods.

Example aspects of the present disclosure provide an example computing system that includes one or more processors and one or more non-transitory computer-readable media storing instructions that are executable by the one or more processors to cause the computing system to perform operations. The operations can include any one or more of the implementations of the example methods.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example embodiments of the present disclosure.

FIG. 2 is a block diagram of an example system according to example embodiments of the present disclosure.

FIG. 3 is a chart illustration of an example weighting function according to example embodiments of the present disclosure.

FIG. 4 is a block diagram of an example system according to example embodiments of the present disclosure.

FIG. 5 is a block diagram of an example system according to example embodiments of the present disclosure.

FIG. 6 is a flow chart diagram illustrating an example method according to example embodiments of the present disclosure.

FIG. 7 is a flow chart diagram illustrating an example method according to example embodiments of the present disclosure.

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Generally, the present disclosure is directed to weighted objective functions and adaptive noise distributions for optimizing machine-learned models trained using noised training data. Example models of the present disclosure can be configured to process noisy inputs to obtain reduced-noise outputs. For instance, a diffusion model can progressively remove noise from an input image to generate new image content. In an aspect, example models can be trained using noisy training examples that have been noised according to a noise distribution (also known as a “noise schedule” in the art). This noise distribution can be dynamically adapted based on an expected loss distribution to stabilize a loss during training. Dynamic adaptation of the noise distribution during training can facilitate improved convergence without costly hand-tuning. This can facilitate more efficient hyperparameter tuning and search. In another aspect, example models can be trained with objectives that weight the loss differently for different noise levels of the training example. The weighting can increase monotonically with noise level to increase an emphasis on learning from examples that contain more noise (e.g., when the reduced-noise outputs can provide the greatest perceptual improvements).

Example aspects of the present disclosure relate to training diffusion models. A diffusion model can be configured for recovering or generating image content by recursively removing noise from an input image. For instance, in an image generation implementation, a diffusion model can be provided a pure noise input. The diffusion model can iteratively “remove” noise from the pure noise input to leave behind image data that is likely to represent a subject associated with a given context. When processing highly noisy inputs, the signal-to-noise ratio of the input is very low. The diffusion model's task is to distinguish coarse features of the desired subject from some quantity of noise and subtract an amount of noise that reveals the coarse features. As more and more noise is removed, the coarse features can be clarified, such that the signal-to-noise ratio increases and the model's task transitions to discerning finer and finer details. At some point, the noise removed in an iterations is effectively imperceptible, and the resulting image can be output as a final generation output.

Training a diffusion model can involve artificially noising a clean training image and tasking the model with removing the artificial noise. The amount of noise for a given training example can be selected according to a noise distribution. To help the model focus on learning to distinguish more perceptible image features, an example loss function can be weighted to apply a greater penalty for more perceptible errors (e.g., errors in larger/coarser features). The weighting function can vary as a function of noise level or signal-to-noise ratio. This variation can cause loss magnitudes to vary significantly for different training examples that are noised with different levels of artificial noise. Advantageously, example implementations of the present disclosure provide an adaptive noise distribution for intelligently selecting an amount of artificial noise for noising respective training examples during training. The adaptive noise distribution can automatically adapt to stabilize loss magnitudes during training, even if weighting functions change. This stabilization can provide for faster convergence during training. Further, the automatic adaptation can allow rapid evaluation of different weighting functions, enabling a new class of hyperparameter search and tuning for weighting functions.

Existing training methods, in contrast, can have highly variable loss values unless the noise distribution is carefully hand-tuned for each implementation. This variability can lead to suboptimal convergence, thereby increasing a computational cost associated with training (e.g., by increasing a number of training iterations required to reach convergence). Additionally, existing methods for adjusting a noise distribution can in some instances involve labor-intensive hand-tuning or complex and computationally costly backpropagation. These challenges can limit the ability to quickly and inexpensively search for improved weighting functions, which can in turn cause diffusion models to be trained based on suboptimal objectives. As a result, existing approaches to training machine-learned models using noised training data have generally focused on specific model architectures (e.g., diffusion architectures), which can in some instances impede architectural improvements or architectural experimentation for noise-based machine-learned models.

Advantageously, the present disclosure provides weighted likelihood-based objectives that can be used to optimize any likelihood-based architecture (e.g., transformer, etc.) using noised training images and using machine-learning objectives configured to optimize a perceptual image quality. This can enable a direct comparison between a diffusion model and a non-diffusion model (e.g., transformer) optimized with respect to a similar (e.g., same) objective. Such a direct comparison may in some instances facilitate further improvements to machine-learned model architectures through experimentation.

More particularly, example aspects of the present disclosure provide systems and methods for optimizing a machine-learned model using weighted likelihood-based objectives that can be invariant to changes in a noise distribution. The weighted objectives can have a weight that is monotonically non-decreasing with respect to a noise level. In some instances, a weighting function of the weighted objective can have an approximately sigmoidal shape when plotted as a curve having a vertical weight axis and a horizontal noise axis. Such a quasi-sigmoidal shape can, in some instances, have a relatively flatter slope near a maximum weight value for a section of the curve associated with high noise levels; a relatively flatter slope near a minimum weight value for a section of the curve associated with low noise levels; and a relatively steeper slope for a section of the curve associated with medium noise levels.

Technical advantages of weighting curves that are monotonically non-decreasing with respect to a noise level can be understood intuitively from the nature of a diffusion-based image generation task or from the nature of human perception. For instance, a diffusion-based image generation task can comprise progressively “removing” noise from a pure noise input. When a noise level of a noised image is extremely low, removing noise may affect fine features of the image (e.g., a texture of a dog's fur), but may have little impact on whether the image resembles a desired image subject (e.g., a golden retriever). In contrast, when a noise level of an input image is higher (e.g., approaching pure noise), removing noise may reveal one or more coarse features of the denoised image (e.g., the general features of a large dog with long fur). And when a noise level of an input image is medium, a denoising process may add medium-coarse features (which may still be relevant to perceptual image quality), building upon coarser features already present in a non-noise component of the medium-noise image. Because changes at higher noise levels can in some instances have a greater impact on perceptual image quality than changes at lower noise levels, a weighting curve that is monotonically non-decreasing with respect to a noise level can consistently maintain or amplify the training signal obtained from examples noised at higher levels.

However, applying too high a weight to the highest noise levels may in some instances lead to poorer empirical results than evenly weighting both high and medium noise levels. Example implementations of the present disclosure provide monotonic weighting functions that include a plateau or shelf over a higher noise region that provides a region of relatively even weighting (e.g., as opposed to exponential growth of weight with noise level) before tapering off in lower noise region(s). For instance, example experiments according to the present disclosure compared sigmoidal monotonic weighting functions of the present disclosure to exponentially monotonic “v-prediction” weighting functions. Models trained using sigmoidal weighting functions according to the present disclosure achieved better FID scores and better IS scores than models trained using v-prediction losses. The better performance of sigmoidal weighting curves may in some instances be explained, at least partially, by avoidance of overfitting associated with applying exponentially increasing weights to a finite training dataset.

Example implementations of the present disclosure can provide monotonic weighting curves with technical advantages over some non-monotonic curves. For example, objective functions using monotonic curves of the present disclosure can have computationally desirable properties not afforded by non-monotonic weighting curves (e.g., compatibility with adaptive noise distributions having improved convergence properties; adaptability to non-diffusion likelihood-based machine-learned models; etc.) Advantageously, weighting functions of the present disclosure can have desirable perceptual properties (e.g., low FID scores) comparable to or better than existing non-monotonic functions, while having additional computationally desirable properties not shared by existing non-monotonic functions.

In some instances, a monotonic weighting curve can be based on a sigmoid function (e.g., the logistic function). For example, a constant can be added to a measure associated with a noise level (e.g., negative log signal-to-noise ratio) to generate a sum, and the weight can be the sigmoid of the sum. In some instances, a monotonic quasi-sigmoidal weighting function can be generated by modifying a non-monotonic weighting function to create a piecewise monotonically non-decreasing function. For example, non-monotonic portions of a function can be replaced with monotonic replacements. For instance, a bell-shaped weighting function can be monotonically increasing on one side of a peak and monotonically decreasing on another. The monotonically decreasing portion can be replaced with a monotonically non-decreasing function (e.g., a constant value, such as the peak value).

In another example aspect, the present disclosure provides systems and methods for determining an adaptive noise distribution. To determine an adaptive noise distribution, a loss distribution can be obtained before or during training of a machine-learned model. The loss distribution can be a distribution of losses associated with a weighted loss function currently being used to train the machine-learned model. For example, during training of a machine-learned model, one or more training examples can be noised, with an amount of noise for each image being based on an initial noise distribution. For each noised training example, the machine-learned model can generate an output, and a loss can be determined based on the output and a weighted loss function. A plurality of such losses can form a distribution of losses with respect to noise level. Based on the distribution of losses, the noise distribution can update to increase a stability of the losses. For example, the noise distribution can be adjusted to decrease a likelihood of using noise levels that would be associated with extreme values of the loss. Next, a second plurality of training examples can be noised, with an amount of noise for each image being based on the updated noise distribution.

For example, the adaptive noise distribution can be configured to decrease an expected variance of a Monte Carlo estimate of the weighted loss function. For example, the loss distribution can be tracked as a plurality of exponential moving averages of losses associated with a plurality of noise level ranges (e.g., 100 evenly spaced noise level bins). The noise distribution can be configured such that a probability of selecting a particular noise level can be approximately proportional to an exponential moving average of losses associated with noise levels in a range associated with that noise level.

In another aspect of the present disclosure, an example method is provided for searching over a weighting function search space for an optimal or improved weighting function for a particular use case. First, a weighting function search space can be obtained. In some instances, the weighting function search space can comprise one or more parameterized weighting functions (e.g., sigmoid function, etc.). A new weighting function can be iteratively selected by updating a parameter of one or more parametrized weighting functions. Using a baseline machine-learned model architecture, training can be conducted with a variety of different weighting functions to determine which weighting function achieves a better performance for a particular use case (e.g., particular model architecture, training dataset, training hyperparameters, number of training iterations, etc.). Advantageously, using an adaptive noise distribution according to aspects of the present disclosure can facilitate improved convergence when training using various different weighting functions without laborious hand-tuning of the noise distribution for each candidate weighting function.

Systems and methods of the present disclosure can have various technical effects and benefits. In some instances, systems and methods of the present disclosure can achieve better technical performance (e.g., better FID scores) than prior systems and methods for a variety of image generation objectives. Additionally, systems and methods of the present disclosure can in some instances achieve similar technical performance at a reduced computational cost (e.g., reduced electricity usage) compared to prior systems and methods. Furthermore, systems and methods of the present disclosure can unlock new avenues of exploration (e.g., experimentation with model architectures, noise-distribution-agnostic experimentation with weighting functions, etc.) not available with prior systems and methods, while maintaining a similar or better technical performance (e.g., similar or better FID score) compared to prior systems and methods.

In some example experiments involving image generation, machine-learned models trained according to the present disclosure achieved better scores on image generation metrics (e.g., lower FID scores, higher IS scores) compared to prior systems and methods. This improved result was seen for multiple sampling techniques (e.g., DDPM sampler, EDM sampler) and multiple image resolutions (e.g., 64×64, 128×128, 256×256, 512×512). Additionally, because machine-learned model performance can in some instances scale with model size, it will be appreciated that methods of the present disclosure can also enable similar-quality image generation using smaller models than prior training methods. Thus, systems and methods of the present disclosure can reduce computational costs associated with operating a machine-learned image generation model by enabling similar image generation performance using a less computationally expensive (e.g., smaller) model.

In some example experiments, adaptive noise distributions according to the present disclosure were compared to prior noise distributions. In some instances, adaptive noise distributions according to the present disclosure converged significantly faster (e.g., reaching a given loss threshold more than 50,000 training iterations sooner in some instances) than prior noise distributions. Thus, systems and methods of the present disclosure can reduce a computational cost associated with training compared to some prior noise distributions, by reducing a number of training iterations required to reach convergence. In other instances (e.g., when a prior noise distribution was already well-tuned with respect to a particular objective, e.g., due to labor-intensive hand-tuning), adaptive noise distributions according to the present disclosure converged at approximately the same rate as some prior noise distributions, without the need for labor-intensive hand-tuning or computationally expensive backpropagation. Thus, adaptive noise distributions of the present disclosure can improve the functioning of a computing system by enabling the training of a machine-learned model at a reduced computational cost.

Additionally, systems and methods of the present disclosure enable the use of machine-learning objectives configured to increase a perceptual image quality to optimize a wide variety of likelihood-based architectures (e.g., transformers, etc.) that may be incompatible with prior diffusion objectives. It will be appreciated that a computational cost associated with a machine-learned model can vary based on an architecture of the machine-learned model (even when controlling for other factors, e.g., model size). Thus, it will be appreciated that systems and methods of the present disclosure can in some instances enable the use of a less computationally expensive likelihood model to perform a similar (e.g., same) task previously performed by a more computationally expensive diffusion model. Thus, it will be appreciated that systems and methods of the present disclosure can in some instances improve the functioning of a computing system by enabling image generation at a reduced computational cost.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Various example implementations are described herein with respect to the accompanying Figures.

### Example Systems

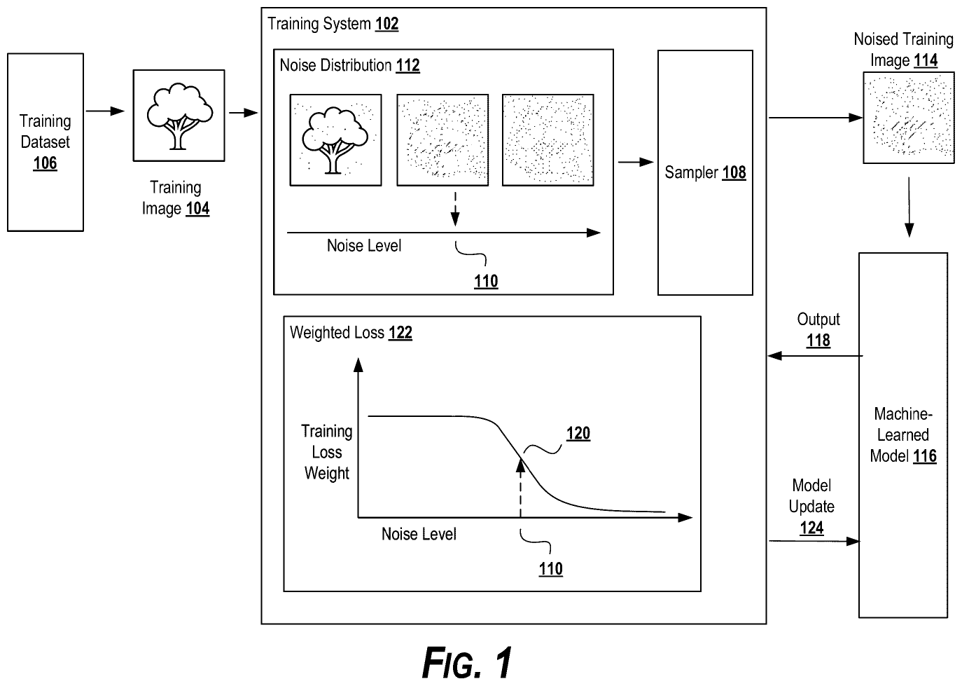

FIG. 1 is a block diagram of an example system according to example embodiments of the present disclosure. A training system 102 can obtain a training image 104 from a training dataset 106. The training system 102 can use a sampler 108 to sample a current noise level 110 from a noise distribution 112. The training system 102 can add noise to the training image 104 according to the current noise level 110 to generate a noised training image 114. A machine-learned model 116 can process the noised training image to generate an output 118. The training system 102 can determine a weighted loss 122 associated with the output 118 by determining a loss and multiplying the loss by a current weight 120 associated with the current noise level 110. Based on the weighted loss 122, the training system 102 can perform a model update 124 on the machine-learned model.

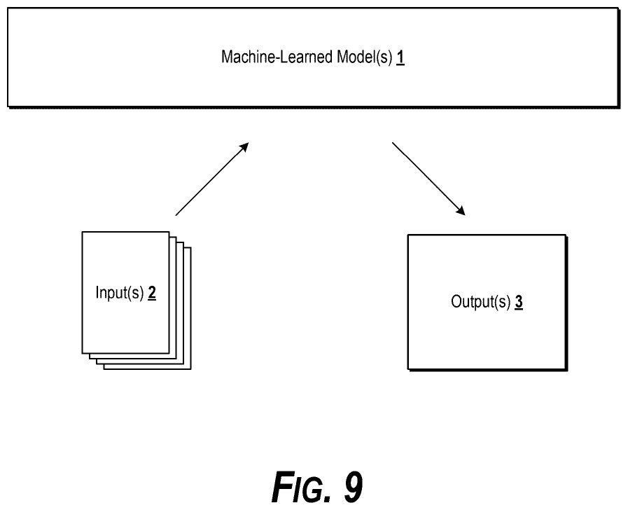

The training system 102 can be, for example, one or more computing systems configured to train one or more machine-learned models. The training system 102 can be located on a single computing system or distributed across multiple computing systems. In some instances, a training system 102 can correspond to a computing system described with respect to FIGS. 9 through 15 (e.g., server computing system 60, etc.).

A training image 104 can include, for example, computer-readable data associated with an image. A training image 104 can include, for example, color images or black and white images. A training image 104 can include video or still images. A training image 104 can in some instances include photographs, drawings, illustrations, visual representations of non-visual data, etc. Visual representations of non-visual data can include, for example, medical imaging, radar imaging, chemical imaging, audio spectrograms, etc. The training image 104 can include, for example, image data such as pixel values, etc. The training image 104 can include, for example, image metadata such as an image category, description, classification, or other metadata. A training image 104 can be or include various types of data. Example data types can include compressed or uncompressed image data, binary or text-based image metadata, machine-learned semantic embeddings associated with an image, etc.

The training dataset 106 can be stored, for example, on one or more non-transitory computer-readable media (e.g., computer-readable media of the training system 102, computer-readable media of a computing system in communication with the training system 102, etc.). A training dataset 106 can include, for example, human-labeled, machine-labeled, or unlabeled images. The training dataset 106 can include, for example, a preexisting dataset, such as a public domain or open-source dataset. A training dataset 106 can include, for example, newly collected or newly generated images that are not part of a preexisting dataset. In some instances, training dataset 106 can include, for example, a distributed collection of image data associated with a plurality of computing devices.

The sampler 108 can be, for example, one or more computing systems configured to sample a current noise level 110 from a noise distribution 112. In some instances, the sampler 108 can be, comprise, be comprised by, implement, or be implemented by a training system 102. The sampler 108 can be located on a single computing system or distributed across multiple computing systems. In some instances, a sampler 108 can correspond to or be implemented by a computing system described with respect to FIGS. 9 through 15 (e.g., server computing system 60, etc.). Sampling a current noise level 110 from the noise distribution 112 can include, for example, generating a random or pseudorandom number. Sampling a current noise level 110 can further include, for example, determining a current noise level 110 based on the random or pseudorandom number and the noise distribution 112. In some instances, the random number can be a number between 0.0 and 1.0. In some instances, determining a current noise level 110 can include selecting a noise level 110 based on the random number and a cumulative distribution function of the noise distribution 112.

In some instances, the current noise level 110 can be or represent an amount of noise to be added to a training image 104 to generate a noised training image 114. The current noise level 110 can be represented using various types of data (e.g., numerical data, etc.) and can be represented in various ways. For example, in some instances, a current noise level 110 can be represented as a signal-to-noise ratio or log signal-to-noise ratio. In some instances, a current noise level 110 can be represented as a number or percentage of pixels of a training image 104 to add noise to. It will be appreciated that other representations are possible. It will be appreciated that a current noise level 110 can also have one or more characteristics (e.g., signal-to-noise ratio, log signal-to-noise ratio) that may in some instances be different from a way the current noise level 110 is represented by the training system 102.

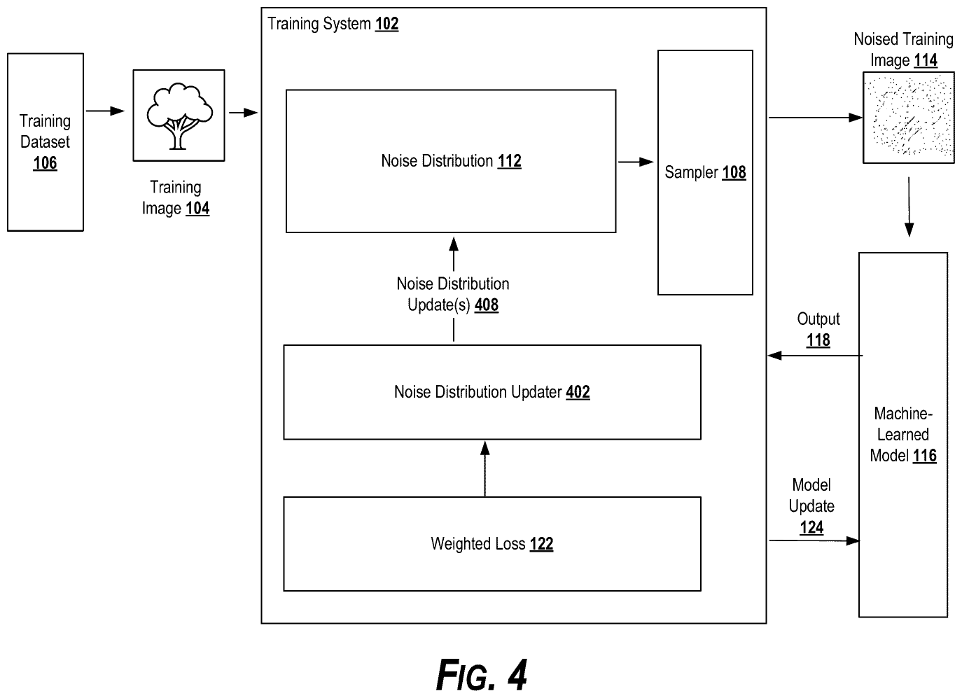

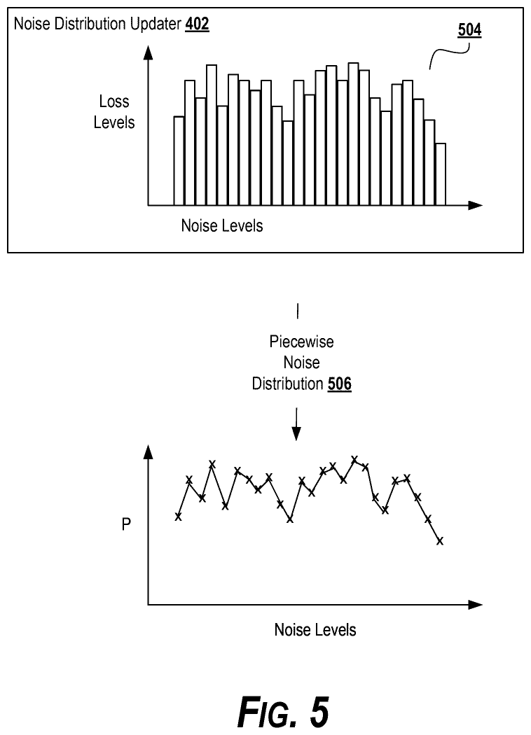

The noise distribution 112 can be associated with a plurality of noise levels 110. In some instances, the noise distribution 112 can have two endpoints (e.g., a first endpoint associated with a minimum noise level, a second endpoint associated with a maximum noise level, etc.). The noise distribution 112 can be or represent, for example, a distribution (e.g., probability distribution) of noise levels 110. The noise distribution 112 can be, for example, a discrete distribution or continuous distribution. In some instances, the noise distribution 112 can be fixed or updatable. Example implementations for adaptively updating a noise distribution 112 are further described below with respect to FIGS. 4 and 5.

A noised training image 114 can include, for example, computer-readable data associated with an image that is generated by noising training image 104. A noised training image 114 can include, for example, color images or black and white images. A noised training image 114 can include video or still images. An associated image can in some instances include photographs, drawings, illustrations, visual representations of non-visual data, etc. Visual representations of non-visual data can include, for example, medical imaging, radar imaging, chemical imaging etc. The noised training image 114 can include, for example, image data such as pixel values, etc. The noised training image 114 can include, for example, image metadata such as an image category, description, classification, or other metadata. A noised training image 114 can be or include various types of data. Example data types can include compressed or uncompressed image data, binary or text-based image metadata, machine-learned semantic embeddings associated with an image, etc. A data type of a noised training image 114 can be the same as or different from one or more data types of a training image 104.

In some instances, a noised training image 114 can be characterized by a current noise level 110. Additionally, it will be appreciated that a noised training image 114 can also have one or more noise characteristics (e.g., signal-to-noise ratio, log signal-to-noise ratio) that may in some instances be different from a way the current noise level 110 is represented by the training system 102. For example, a person skilled in the art will appreciate that noised data (including, e.g., a noised training image 114) can generally be characterized by a signal-to-noise ratio. For example, a person skilled in the art will appreciate that a signal-to-noise ratio of noised data can be determined, for example, by comparing the noised data to a ground truth value associated with unnoised data (e.g., a training image 104).

In some instances, generating a noised training image 114 can comprise adding noise (e.g., Gaussian noise) to the image (e.g., according to a Gaussian diffusion process). In some instances, generating a noised training image 114 can comprise sampling a noise value from a Gaussian distribution [symbol] (0, I). In some instances, generating a noised training image 114 can comprise combining the noise value with a training image 104 according to a current noise level 110. In some instances, combining the noise value with the training image 104 can comprise multiplying the noise value by a first scaling factor to generate a first product, multiplying data indicative of the training image 104 by a second scaling factor to generate a second product, and adding the first product to the second product. In some instances, this process can be written as

$${z}_{t} = {α}_{λ} {x}_{0} + {σ}_{λ} ϵ$$

where zₜ can be a noised training image 114, α_{λ} can be a weight applied to x₀, an input training image 104, and σ₂ can be a weight applied to a noise value tensor ϵ. Values populating the noise value tensor can be sampled from a normal distribution. The coefficients α_{λ} and σ_{λ} can be parameterized by a desired noise level parameter λ. In an example, λ can represent a signal-to-noise-ratio (SNR) for a given t, such as a log SNR. Noising a given input image x₀ can proceed by sampling a value of t from a uniform distribution (or other distribution) and using a mapping from t to λ to return a value of λ. The value of λ can then be used to compute the coefficients for noising the image.

In some instances, a noised training image 114 can be generated according to a variance-preserving forward process. For example, in some instances, α_{λ}² can be equal to the logistic function of a log-signal-to-noise ratio λ associated with the current noise level 110. In some instances, σ_{λ}² can be equal to the logistic function of a negative log-signal-to-noise ratio −λ associated with the current noise level 110. In some instances, a log-signal-to-noise-ratio can be equal to log (α_{λ}²/σ_{λ}²).

In some instances, the machine-learned model 116 can receive one or more additional inputs other than the noised training image 114. For example, in some instances the machine-learned model 116 can use, as input, an output associated with a language model. In some instances the machine-learned model 116 can use, as input, machine-learned semantic embedding associated with a pretrained encoder.

The machine-learned model 116 can be or include various different types of machine-learned model architectures. The machine-learned model 116 can be or include a model configured to generate one or more outputs based on a noisy input (e.g., noised image input, pure noise input, etc.). In some instances, the machine-learned model 116 can be configured to process the noised image and identify the noise in the image for removing the noise from the image. The machine-learned model 116 can output the noise to be removed or can output a denoised image directly. In some instances, the machine-learned model 116 can be configured to predict noise iteratively, either in discrete stages or according to a continuous process. In some instances, the machine-learned model 116 can be or include a diffusion model. In some instances, the machine-learned model 116 can be or include a likelihood-based machine-learned model (e.g., transformer model, variational autoencoder, etc.).

An output 118 can generally include or otherwise represent various types of data. An output 118 can include one type or many different types of data. An output 118 can include data of the same type(s) or different types as compared to a training image 104. In some instances, an output 118 can include data indicative of a denoised image. In some instances, an output 118 can include data indicative of a predicted noise value. It will be appreciated that other outputs 118 are possible.

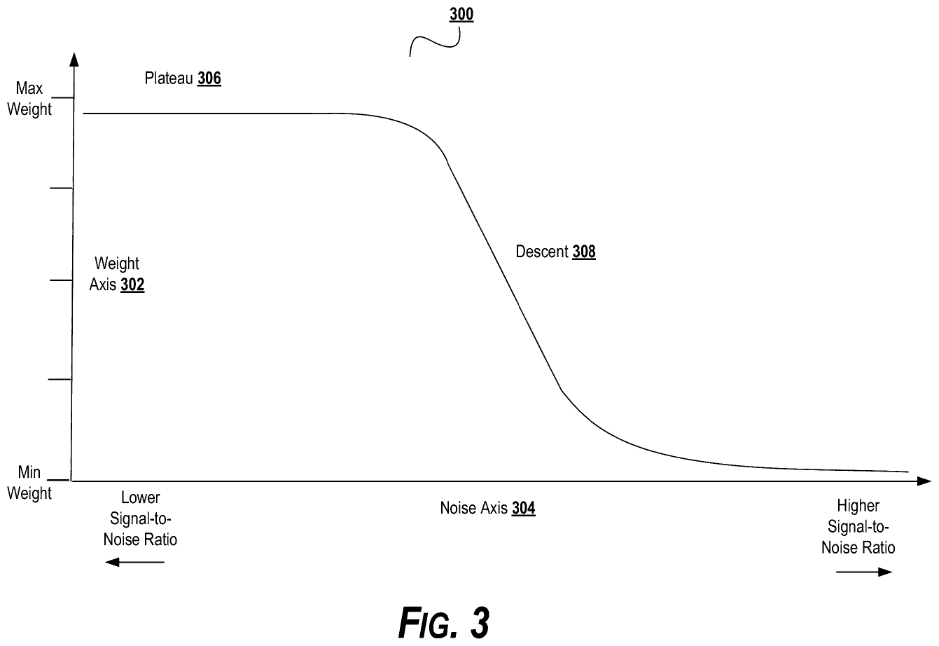

The current weight 120 can comprise, for example, numerical data. In some instances, the current weight 120 can include floating-point numerical data. In some instances, the current weight 120 can include a floating-point number between a minimum weight and maximum weight (e.g., 0.0 and 1.0). In some instances, a current weight 120 can be associated with a current noise level 110 based on a weighting function (e.g., continuous weighting function, piecewise weighting function, etc.). A weighting function can be a function configured to adjust a weight based on a noise level. In some instances, a weighting function can be a mapping (e.g., a one-to-one mapping) between a plurality of noise levels and a plurality of weights 120. Example implementations of weighting functions are further described below with respect to FIG. 3.

The weighted loss can be, for example, a weighted training loss associated with an output 118. The weighted loss 122 can be determined, for example, based on a first training loss and a current weight 120. In some instances, determining a weighted loss 122 based on a first training loss and a current weight 120 can comprise multiplication. For example, determining a weighted loss 122 can include multiplying a first training loss or a component of a first training loss by the current weight 120. In some instances, a weighted loss 122 can be configured to apply a greater penalty to more perceptible errors (e.g., errors in larger/coarser features). For example, in some instances a current weight 120 can be configured such that an expected value of a weighted loss 122 can vary significantly for different noised training images 114 that have been noised based on different current noise levels 110.

In some instances, a first training loss can be or correspond to an evidence lower bound. In some instances, a first training loss can be expressed by the equation

$$\frac{1}{2} {𝔼}_{t \sim 𝒰 ( 0 , 1 ) , ϵ \sim 𝒩 ( 0 , I )} [ - \frac{d λ}{dt} {‖ {\hat{ϵ}}_{θ} ( {z}_{t} ; {λ}_{t} ) - ϵ ‖}_{2}^{2} ] ,$$

where [symbol] can be an expected value operator, U can be a uniform distribution, N can be a normal distribution,

$$\frac{d λ}{dt}$$

can be a derivative (slope) of a noise distribution 112, ϵ can be an actual noise value (e.g., pixel-by-pixel noise value) associated with a noised training image 114, and \hat{ϵ}_{θ} (zₜ; λₜ) can be a predicted noise value generated by a machine-learned model 116 (e.g., a value associated with an output 118). In such instances, a weighted training loss 122 can correspond, for example, to the following expression, wherein w(λₜ) can be a current weight 120 associated with a current noise level 110:

$$\frac{1}{2} {𝔼}_{t \sim 𝒰 ( 0 , 1 ) , ϵ \sim 𝒩 ( 0 , I )} [ w ( {λ}_{t} ) \cdot - \frac{d λ}{dt} {‖ {\hat{ϵ}}_{θ} ( {z}_{t} ; {λ}_{t} ) - ϵ ‖}_{2}^{2} ] .$$

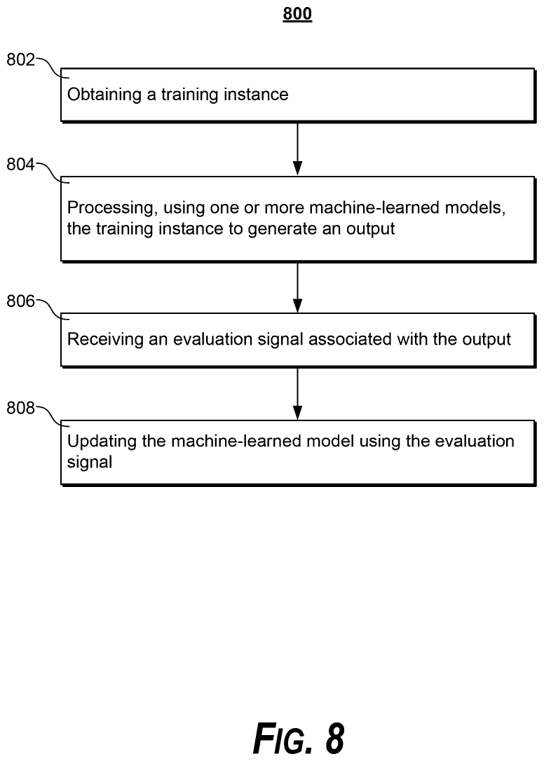

In some instances, determining a weighted loss or first training loss can correspond to one or more steps (e.g., evaluation signal determination step) described below with respect to FIG. 8.

FIG. 1 depicts a model update 124 being performed by the training system 102. Performing a model update 124 can comprise modifying a current state (e.g., one or more respective current values of one or more parameters) of the machine-learned model 116. In some instances, the model update 124 can be based on one or more weighted losses 122. In some instances, performing a model update 124 can comprise one or more steps (e.g., gradient update steps) discussed below with respect to FIG. 8.

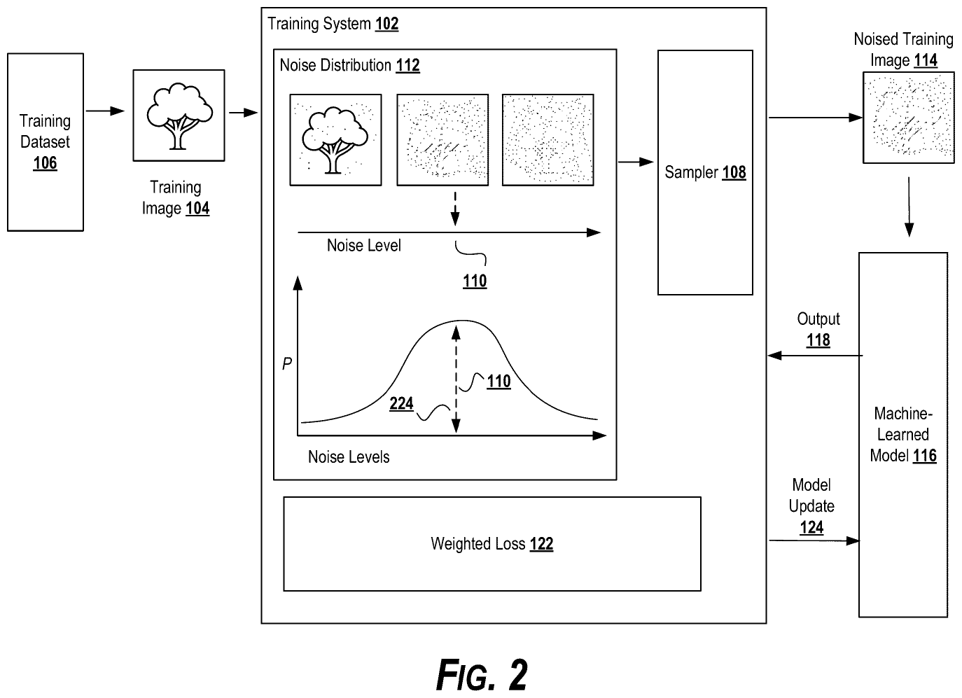

FIG. 2 is a block diagram of an example system according to example embodiments of the present disclosure. FIG. 2 depicts a noise distribution 112 characterized by one or more sampling probabilities 224. The training system 102 can use a sampler 108 to sample a current noise level 110 from the noise distribution 112, wherein a probability of selecting a particular noise level can be equal to a sampling probability 224 associated with that noise level.

The sampling probability 224 can be, comprise, or be represented by numerical data. In some instances, the sampling probability 224 can be represented by floating-point data. In some instances, the sampling probability 224 can be represented by a floating-point number between 0.0 and 1.0. In some instances, a respective sampling probability 224 can be based on a noise distribution 112 associating one or more noise levels 110 with one or more corresponding sampling probabilities 224. In some instances, a respective sampling probability 224 can be based on a discrete or continuous probability distribution function of a noise distribution 112. In some instances, a sum (e.g., discrete sum, continuous integral, etc.) of a plurality of sampling probabilities 224 (e.g., all sampling probabilities 224 between two endpoints of a noise distribution 112) can be equal to 1. In some instances, sampling a current noise level 110 can comprise generating a random number between 0.0 and 1.0, and determining a current noise level 110 based on the random number and a distribution (e.g., cumulative distribution function) of sampling probabilities 224.

In some instances, one or more sampling probabilities 224 can be fixed or updatable. For example, in some instances one or more sampling probabilities can be adaptively updated based on one or more past weighted losses 122 to improve a convergence time associated with the training process. Example implementations for adaptively updating one or more sampling probabilities 224 are further described below with respect to FIGS. 4 and 5.

FIG. 3 is a chart illustration of an example weighting function 300 according to example embodiments of the present disclosure. When plotted on a chart having a weight axis 302 and a noise axis 304, the weighting function 300 can be a monotonically non-increasing function with respect to a signal-to-noise ratio. In some instances, the weighting function 300 can include a higher-weight plateau region 306 associated with high noise levels. In some instances, the weighting function 300 can include a descent region 308, in which weight can decrease as a noise level decreases.

In some instances, the weighting function 300 can be monotonically non-increasing with respect to a signal-to-noise ratio. For example, as a signal-to-noise ratio increases, a weight can decrease with signal-to-noise ratio at some points of a weighting curve 300 and can remain the same as the signal-to-noise ratio increases at some points of the weighting curve 300 (e.g., without ever increasing as a signal-to-noise ratio increases).

It will be appreciated that a signal-to-noise ratio of a noised training image 114 can be inversely related to other measures of noise associated with a noised training image 114. Thus, it will be appreciated that a weighting curve 300 that is monotonically non-increasing with respect to a signal-to-noise ratio can be monotonically non-decreasing with respect to another measure of noise associated with a noised training image 114.

The weight axis 302 can represent, for example, one or more possible weight values that a current weight 120 can take. In some cases, the weight axis 302 can be characterized by a minimum weight (e.g., a minimum possible value that a current weight 120 can take) and a maximum weight.

The noise axis 304 can represent, for example, signal-to-noise-ratio values or log-signal-to-noise-ratio values associated with a current noise level 110. In some cases, the noise level axis 304 can be characterized by a minimum signal-to-noise ratio and a maximum signal-to-noise ratio (e.g., associated with a minimum-signal-to-noise-ratio endpoint and a maximum-signal-to-noise-ratio endpoint of a noise distribution 112).

In some instances, the plateau region 306 can be characterized by an approximately flat (e.g., weight varying by less than 20 percent, 10 percent, 5 percent, 2 percent, etc.) average slope when plotted with respect to a weight axis 302 and noise axis 304. In some instances, a weighting function 300 can be characterized by a finite maximum weight. In some instances, a finite maximum weight can be a maximum weight associated with a maximum-noise endpoint of a noise distribution 112. In some instances, a finite maximum weight can be a finite maximum weight over a natural domain of the weighting function (e.g., as a signal-to-noise ratio tends toward negative infinity). In some instances, the plateau region 306 can be characterized by a high weight relative to the maximum weight. For example, in some instances the plateau region 306 can have an average weight or minimum weight greater than 70 percent, 80 percent, 90 percent, 95 percent or 99 percent of the maximum.

In some instances, the descent region 308 can be characterized by a transition from higher weights associated with lower signal-to-noise ratios (e.g., characterized by more noise, lower signal, etc.) to lower weights associated with higher signal-to-noise ratios (e.g., characterized by less noise, stronger signal, etc.). In some instances, the descent region 308 can comprise a transition from a high weight or near-maximum weight (e.g., greater than 80 percent of maximum, 90 percent, 95 percent, 98 percent, etc.) to a low weight or near-minimum weight (e.g., less than 20 percent of maximum weight, 10 percent, 5 percent, 2 percent, etc.). In some instances, the descent region 308 can be characterized by a relatively steep average slope compared to the plateau region 306. For example, in some instances, an average normalized slope of the descent 308 can be greater than 0.2 (greater than 0.1, 0.05, etc.) if plotted on a curve of weight vs. log signal-to-noise ratios. For example, in some instances, a log signal-to-noise ratio difference of 1 can be associated with a weight change greater than 20 percent of a difference between a minimum and maximum weight of the weighting function 300.

In some instances, a weighting function 300 can have an approximately sigmoidal shape. For example, the weighting function 300 can comprise an approximately flat plateau 306, a steeper descent 308, and an approximately flat lower-weight region associated with high signal-to-noise ratios. In some instances, a weighting function 300 can comprise a sigmoid function. In some instances, the sigmoid function can be a logistic function, such as

$$\frac{1}{1 + {e}^{- x}} .$$

In other instances, the weighting function 300 can be based on another sigmoid function. Other sigmoid functions can include, for example, a hyperbolic tangent, arctangent, Gudermannian function, error function, generalized logistic function, smoothstep function, sigmoidal algebraic function, Gompertz curve, etc. For example, in some instances, a weighting function 300 can comprise a function

$$b \cdot sigmoid ( c \cdot - {λ}^{d} ) + k ) \qquad ( 1 )$$

(e.g., sigmoid(−λ+k)), wherein b, c, d, and k can be real-number-valued constants and λ can be a value indicative of a noise level (e.g., log signal-to-noise ratio). In other instances, a weighting function 300 can have an approximately sigmoidal shape without comprising a sigmoid function (e.g., an approximately bell-shaped function modified to be monotonic, etc.). For example, in some instances, a monotonic quasi-sigmoidal weighting function can be generated by modifying a non-monotonic weighting function to create a piecewise monotonically non-increasing function. For example, non-monotonic portions of a function can be replaced with monotonic replacements. For instance, a bell-shaped weighting function can be monotonically increasing on one side of a peak and monotonically decreasing on another. The monotonically increasing portion can be replaced with a monotonically non-increasing function (e.g., a constant value, such as the peak value).

In some instances, the weighting function 300 can share one or more properties with a sigmoid function (e.g., without comprising a sigmoid function). For example, the weighting function can be characterized by a steepest point associated with a noise level that is approximately equal to (e.g., log-signal-to-noise-ratio difference less than 2 percent, 5 percent, 10 percent, 20 percent, etc.) a noise level associated with a steepest point of function (1). In some instances, the steepest point can be associated with a noise level that is not an endpoint of the noise level distribution 112. In some instances, the weighting function 300 can be characterized by a minimum and maximum weight over a range of noise levels associated with a noise level distribution 112. In such instances, a weight associated with a noise level (e.g., characterized by a log signal-to-noise ratio of zero, 2.5, −2.5, etc.) can be a proportion of the maximum weight. In such instances, the proportion can be equal or approximately equal (e.g., difference of 2 percent, 5 percent, 10 percent, 20 percent, etc.) to a function (1) associated with a same noise level (e.g., wherein the sigmoid function is associated with a maximum possible value of 1.0 and minimum possible value of 0.0). In some instances, the weighting function 300 can comprise one or more regions characterized by one or more average slopes forming an approximately sigmoidal shape. For example, in some instances a weighting function can comprise a first region having an approximately flat slope, a second region having a steeper slope, and a third region having an approximately flat slope. In some instances, a first, second, or third region can be characterized by an average slope that is similar to (e.g., difference less than 2 percent, 5 percent, 10 percent, 20 percent, etc.) a function (1) associated with a same range of noise levels. A person skilled in the art will recognize that a sigmoid function can have many other properties not listed herein.

In some instances, a weighting function 300 can be determined by modifying a non-monotonic weighting function to generate a monotonic function. Non-monotonic functions that can be modified include, for example, a non-monotonic weighting function associated with a non-monotonic diffusion objective. Example weighting functions associated with non-monotonic diffusion objectives can include an EDM weighting function, IDDPM, P2 weighting, Min-SNR-Y, etc. For example, in some instances, a non-monotonic function (e.g., an approximately bell-shaped function) can have a maximum weight and a noise level associated with the maximum weight. In some instances, a monotonic function can be generated based on the non-monotonic function. For example, in some instances, one or more weights associated with a non-monotonic portion of the non-monotonic function may be adjusted (e.g., decreased, increased, clipped, etc.) to make the non-monotonic portions monotonic. For example, in some instances, one or more weights can be adjusted to be equal to a local extremum (e.g., local minimum, local maximum) to cause a slope of the modified monotonic function to be zero in instances where a positive or negative slope of the non-modified function would cause the function to be non-monotonic. For example, in some instances an approximately bell-shaped function (e.g., hyperbolic secant, etc.) may comprise a partial function (e.g., a partial function comprising all noise levels lower than a noise level associated with a maximum weight) that is monotonic (e.g., monotonically non-increasing with a measure of signal-to-noise ratio). In such instances, weight values not associated with the monotonic partial function (e.g., weight values associated with lower signal-to-noise ratios than a noise level associated with the maximum weight) can be adjusted to be monotonically non-increasing (e.g., equal to the maximum weight).

In some instances, the weighting function 300 can be configured such that an expected value associated with one or more weighted losses 122 is invariant to a change to a noise distribution 112 other than a change of the noise distribution's endpoints. For example, in instances where a first training loss can be written as

$$\frac{1}{2} {𝔼}_{t ∼ 𝒰 ( 0 , 1 ) , ϵ ∼ 𝒩 ( 0 , I )} [ - \frac{d λ}{dt} {‖ {\hat{ϵ}}_{θ} ( {z}_{t} ; {λ}_{t} ) - ϵ ‖}_{2}^{2} ]$$

and weighted loss can be written as

$$\frac{1}{2} {𝔼}_{t ∼ 𝒰 ( 0 , 1 ) , ϵ ∼ 𝒩 ( 0 , I )} [ w ( {λ}_{t} ) * - \frac{d λ}{d t} {‖ {\hat{ϵ}}_{θ} ( {z}_{t} ; {λ}_{t} ) - ϵ ‖}_{2}^{2} ] ,$$

it will be appreciated that a monotonic weighting function 300 can correspond to an expected value of one or more weighted losses 122 that can be invariant to a change in noise distribution 112 other than a change of endpoints. In such instances, an expected value of a weighted diffusion loss can be written as

$$\frac{1}{2} {\int }_{{λ}_{min}}^{{λ}_{max}} w ( λ ) {𝔼}_{ϵ ∼ 𝒩 ( 0 , I )} [ {‖ {\hat{ϵ}}_{θ} ( {z}_{λ} ; λ ) - ϵ ‖}_{2}^{2} ] d λ , \qquad ( 2 )$$

wherein w(λ) can be a weighting function 300, λ can be a noise level metric (e.g., log signal-to-noise ratio), and λₘᵢₙ and λₘₐₓ can be noise levels (e.g., log signal-to-noise ratios) associated with the two endpoints of a noise distribution 112. It will be appreciated that a magnitude of the above integral depends on the minimum and maximum noise levels of the noise distribution 112 but in some instances does not otherwise depend on a shape of the noise distribution 112. For example, in instances where a noise distribution 112 is based on a mapping f_{λ} from a value t to a plurality of noise levels 110, an expected value of the weighted diffusion loss (2) when tis sampled from [symbol] (0,1) can be invariant to f_{λ} except at the endpoints, such as 0.0 and 1.0.

In some instances, the weighting function 300 can be configured such that the weighted loss 122 is equivalent to an evidence lower bound with data augmentation (e.g., wherein the data augmentation is additive Gaussian noise). For example, it will be appreciated that in instances where a first training loss can be written as

$$\frac{1}{2} {𝔼}_{t ∼ 𝒰 ( 0 , 1 ) , ϵ ∼ 𝒩 ( 0 , I )} [ - \frac{d λ}{d t} {‖ {\hat{ϵ}}_{θ} ( {z}_{t} ; {λ}_{t} ) - ϵ ‖}_{2}^{2} ] ,$$

and the weighting function 300 is monotonic with respect to noise level, a weighted diffusion objective written as

$$\frac{1}{2} {𝔼}_{t ∼ 𝒰 ( 0 , 1 ) , ϵ ∼ 𝒩 ( 0 , I )} [ w ( {λ}_{t} ) * - \frac{d λ}{d t} {‖ {\hat{ϵ}}_{θ} ( {z}_{t} ; {λ}_{t} ) - ϵ ‖}_{2}^{2} ]$$

will be equivalent to an evidence lower bound with additive noise. Further derivations are provided in Kingma and Gao, Understanding Diffusion Objectives as the ELBO with Simple Data Augmentation, available at https://arxiv.org/pdf/2303.00848.pdf, which is hereby incorporated by reference herein in its entirety. It will be further appreciated that in instances where a weighting function is non-monotonic, a weighted diffusion objective written as

$$\frac{1}{2} {𝔼}_{t ∼ 𝒰 ( 0 , 1 ) , ϵ ∼ 𝒩 ( 0 , I )} [ w ( {λ}_{t} ) * - \frac{d λ}{d t} {‖ {\hat{ϵ}}_{θ} ( {z}_{t} ; {λ}_{t} ) - ϵ ‖}_{2}^{2} ]$$

can equate to a weighted integral of evidence lower bounds over different noise levels.

In some instances, a plurality of weighting functions 300 can be tested and compared. For example, in some instances, a weighting function search space can be defined, and one or more weighting functions 300 can be iteratively selected from the weighting function search space. In some instances, a weighting function search space can include one or more parameterized functions (e.g., sigmoid functions, e.g., logistic function, hyperbolic tangent, arctangent, Gudermannian function, error function, generalized logistic function, smoothstep function, sigmoidal algebraic function, Gompertz curve, etc.). In some instances, one or more weighting functions 300 can be iteratively selected based on a parameterized function by iteratively updating one or more parameters of the parameterized function. For example, in some instances a weighting function 300 can be iteratively selected by incrementing or decrementing one or more parameters. In some instances, a respective parameter can be incremented or decremented by a fixed amount or variable amount. For example, in some instances a parameterized function can be written as b*sigmoid(c*−λ^{d})+k). In such instances, a weighting function 300 can be iteratively selected by incrementing or decrementing (e.g., adding or subtracting 0.1, 0.5, 1.0, etc.) one or more of b, c, d, and k. In some instances, the weighting function search space can be configured such that a plurality of functions of the weighting function search space can share one or more desirable properties (e.g., approximately sigmoidal shape, monotonicity, invariance to probabilities of a noise distribution 112, etc.). In some instances, a plurality of weighting functions 300 can be used to train one or more machine-learned models 116, and a performance associated with each weighting function 300 can be measured and compared.

FIG. 4 is a block diagram of an example system according to example embodiments of the present disclosure, wherein an adaptive noise distribution can be implemented. A noise distribution updater 402 can obtain one or more weighted losses 122 and can perform, based on the one or more weighted losses 122, one or more noise distribution update(s) 408 to update the noise distribution 112.

The noise distribution updater 402 can be, for example, one or more computing systems configured to update a noise distribution 112. In some instances, the noise distribution updater 402 can be, comprise, be comprised by, implement, or be implemented by a training system 102. The noise distribution updater 402 can be located on a single computing system or distributed across multiple computing systems. In some instances, a noise distribution updater 402 can correspond to or be implemented by a computing system described with respect to FIGS. 9 through 15 (e.g., server computing system 60, etc.).

Performing a noise distribution update 408 can comprise, for instance, replacing a noise distribution 112 with an updated noise distribution 112; modifying one or more values of a noise distribution 112; or any other means of updating a noise distribution 112. In some instances, a noise distribution update 408 can be based on one or more weighted losses 122 (e.g., a distribution of weighted losses 122). In some instances, a noise distribution update 408 can be performed periodically (e.g., one noise distribution update 408 per n training iterations, where n can be an integer).

In some instances, the noise distribution update 408 can be configured to improve an efficiency (e.g., a convergence time) of a training process. For example, as discussed above with respect to FIG. 3, an expected loss or total loss associated with a weighted loss function according to the present disclosure can in some instances be invariant to any part of a noise distribution 112 other than the noise distribution 112's endpoints. However, in some instances, a training process can rely on a Monte Carlo process (e.g., in which a current noise level 110 is sampled by a sampler 108, and a weighted loss 122 associated with the current noise level 110 is determined). In such instances, the weighted losses 122 can be considered a Monte Carlo estimator of an expected loss or total loss. In such instances, all portions of a noise distribution 112 can affect a variance of the Monte Carlo estimator and its gradients. Because the noise distribution 112 can affect a variance of the Monte Carlo estimator of loss, the noise distribution 112 can affect an efficiency (e.g., convergence time, etc.) of an optimization process. For example, in some instances, an inefficient noise distribution 112 may assign a high sampling probability 224 to a range of noise levels that may have little impact on a final outcome (e.g., final model parameters) of a training process (e.g., due to low weighted losses 122). In such instances, many training iterations may be spent performing operations that do not bring a model much closer to convergence. In such instances, a convergence time can be reduced by reducing a sampling probability 224 associated with one or more noise levels associated with low Monte Carlo estimates of weighted loss, and increasing a sampling probability 224 associated with one or more noise levels associated with higher Monte Carlo estimates of weighted loss. In this manner, for instance, a noise distribution 112 can in some instances act as an importance sampling distribution for estimating an expected or total loss. Thus, it will be appreciated that a noise distribution 112 can in some instances be optimized to improve an efficiency of a training process, without affecting an expected final outcome of the training process.

In some instances, a noise distribution update 408 can be configured to decrease (e.g., minimize) an expected variance associated with a plurality of weighted losses 122. For example, in some instances a noise distribution update 408 can be configured such that each respective sampling probability 224 is approximately proportional to an expected weighted loss 122 associated with a noise level 110 corresponding to the sampling probability 224. In some instances, this can be written as

$$p ( λ ) ∝ {𝔼}_{x ∼ D , ϵ ∼ 𝒩 ( 0 , I )} [ w ( λ ) {‖ {\hat{ϵ}}_{θ} ( {z}_{λ} ; λ ) - ϵ ‖}_{2}^{2} ] ,$$

where p(λ) can be a sampling probability 224 (p) associated with a noise level 110 (λ), and

$${𝔼}_{x ∼ D , ϵ ∼ 𝒩 ( 0 , I )} [ w ( λ ) {‖ {\hat{ϵ}}_{θ} ( {z}_{λ} ; λ ) - ϵ ‖}_{2}^{2} ]$$

can be an expected value of a weighted loss. This proportionality can provide that that an expected weighted loss can be spread evenly with respect to a noise distribution 112. For example, a magnitude of a ratio between an expected weighted loss 122 and a sampling probability 224, written as

$${𝔼}_{x ∼ D , ϵ ∼ 𝒩 ( 0 , I )} [ \frac{w ( λ )}{p ( λ )} {‖ {\hat{ϵ}}_{θ} ( {z}_{λ} ; λ ) - ϵ ‖}_{2}^{2} ] ,$$

can be approximately invariant to λ. For example, in implementations where λ is determined by randomly sampling a value (e.g., uniformly between 0.0 and 1.0) and determining a current noise level 110 based on that value and the noise distribution 112, the magnitude of a ratio between an expected weighted loss 122 and a sampling probability 224 can be approximately invariant to a magnitude of the sampled value.

In some instances, the noise distribution update 408 can be based, at least in part, on a distribution of past values of weighted loss 122. For example, in some instances, an expected value of one or more weighted losses 122 can be estimated based on past values of weighted loss 122, and one or more sampling probabilities 224 can be determined based on the estimated expected value (e.g., such that

$$p ( λ ) ∝ {𝔼}_{x ∼ D , ϵ ∼ 𝒩 ( 0 , I )} [ w ( λ ) {‖ {\hat{ϵ}}_{θ} ( {z}_{λ} ; λ ) - ϵ ‖}_{2}^{2} ] ) .$$

Additional example implementations for determining a noise distribution update 408 based on one or more weighted losses 122 are further described below with respect to FIG. 5.

FIG. 5 is a block diagram of an example system according to example embodiments of the present disclosure, wherein an adaptive noise distribution is implemented. A noise distribution updater 402 can obtain a loss distribution 504 and can generate a piecewise noise distribution 506 based on the loss distribution 504.

The loss distribution 504 can be, for example, a distribution (e.g., discrete distribution, continuous distribution, etc.) of one or more weighted losses 122 (e.g., past values of weighted loss 122, e.g., from past training iterations associated with a same or different machine-learned model 116). In some instances, the loss distribution 504 can comprise, for example, one or more average loss values (e.g., exponential moving average of weighted losses 122, etc.) In some instances, the loss distribution 504 can comprise one or more bins, such that each bin is associated with one or more noise levels 110. For example, in some instances, the loss distribution 504 can comprise a number (e.g., 50, 100, 200, etc.) of discrete bins (e.g., evenly spaced bins), with each bin being associated with a range of noise levels 110. In some instances, the loss distribution 504 can comprise an average loss value (e.g., exponential moving average of weighted losses 122) associated with each bin. In some instances, a loss distribution 504 can be updated periodically (e.g., at each training iteration, etc.).

A piecewise noise distribution can be, for example, a probability distribution associated with one or more noise levels 110. In some instances, the piecewise noise distribution 506 can be, comprise, or be comprised by a noise distribution 112. In some instances, a piecewise noise distribution 506 can be determined such that the piecewise noise distribution 506 approximately satisfies the relationship

$$p ( λ ) ∝ {𝔼}_{x ∼ D , ϵ ∼ 𝒩 ( 0 , I )} [ w ( λ ) {‖ {\hat{ϵ}}_{θ} ( {z}_{λ} ; λ ) - ϵ ‖}_{2}^{2} ] ) .$$

For example, in some instances, a piecewise distribution can comprise a number of vertices (e.g., equal to a number of bins of a loss distribution 504) and a number of edges (e.g., straight line segments) between the vertices. In some instances, a noise level associated with each vertex can be equal to a noise level associated with a corresponding bin of a loss distribution 504 (e.g., a center noise level of a bin; a minimum or maximum noise level of a bin; etc.). In some instances, a probability associated with each vertex can be proportional to a loss value associated with a corresponding bin of a loss distribution 504. In some instances, a plurality of probability-noise level pairs associated with each edge can be a linear interpolation between two probability-noise level pairs of the two vertices that the edge is located between. In some instances, a probability associated with each vertex can be normalized such that a sum (e.g., integral) of all probabilities over all noise levels between a minimum noise level and maximum noise level can be 1.0. In some instances, a piecewise noise distribution 506 can be updated at each training iteration.

### Example Results

In some example experiments according to the present disclosure, weighting functions and adaptive noise distributions of the present disclosure were compared to prior weighting functions and prior fixed noise distributions.

In some example experiments according to the present disclosure, weighting functions according to the present disclosure were compared to prior weighting functions. For example, a prior non-monotonic ϵ-prediction model (using a ϵ-prediction loss and cosine noise distribution) was compared to 5 weighting functions according to the present disclosure using a DDPM sampler. The ϵ-prediction model corresponds to an equivalent weighting of

$$w ( λ ) = sec h ( \frac{λ}{2} )$$

with respect to a first training loss

$$\frac{1}{2} {𝔼}_{t ∼ 𝒰 ( 0 , 1 ) , ϵ ∼ 𝒩 ( 0 , I )} [ - \frac{d λ}{dt} {‖ {\hat{ϵ}}_{θ} ( {z}_{t} ; {λ}_{t} ) - ϵ ‖}_{2}^{2} ]$$

as described with respect to FIG. 1. The weighting functions according to the present disclosure were w(λ)=sigmoid(−λ+k), with k equal to 1, 2, 3, 4, or 5. Four of the weighting functions of the present disclosure were associated with better inception scores and FID scores than the prior ϵ-prediction model, with the best scores associated with a k of 2 (w(λ)=sigmoid(−λ+2)). A table of example results is provided below.

| | FID Score | IS score |
|---|---|---|
| Weighting Function | (lower is better) | (higher is better) |
| Prior ϵ-prediction: sech(λ/2) | 1.85 | 54.1 +/− 0.79 |
| sigmoid(−λ + 1) | 1.75 | 55.3 +/− 1.23 |
| sigmoid(−λ + 2) | 1.68 | 56.8 +/− 0.85 |
| sigmoid(−λ + 3) | 1.73 | 56.1 +/− 1.36 |
| sigmoid(−λ + 4) | 1.8 | 55.1 +/− 1.65 |
| sigmoid(−λ + 5) | 1.94 | 53.5 +/− 1.12 |

In another example experiment, a prior non-monotonic EDM weighting function was compared to two weighting functions of the present disclosure: w(λ)=sigmoid(−λ+2) (the best-performing function of the example experiment described above), and a modified EDM weighting function configured to be monotonic. The modified EDM weighting function was configured so that the weight was equal to the prior EDM weight for all noise levels lower than a noise level associated with a maximum weight of the prior EDM weighting function, and equal to the prior maximum weight for all noise levels higher than the noise level associated with the prior maximum weight. In the experiment, weighting functions of the present disclosure were associated with a better inception score and similar FID scores to the prior EDM weighting function. A table of example results is provided below:

| | FID Score | IS score |
|---|---|---|
| Weighting Function | (lower is better) | (higher is better) |
| Prior EDM | 1.45 | 60.7 +/− 1.19 |
| Modified EDM-monotonic | 1.43 | 63.7 +/− 1.14 |
| sigmoid(−λ + 2) | 1.55 | 63.7 +/− 1.48 |

In another example experiment, a prior v-prediction objective was compared to two weighting functions of the present disclosure: sigmoid(−λ+2) and the monotonic modified EDM function described in the preceding paragraph. The v-prediction objective corresponded to exponentially monotonic weighting (having exponentially increasing weight as noise level increases) relative to a first training loss of

$$\frac{1}{2} {𝔼}_{t ∼ 𝒰 ( 0 , 1 ) , ϵ ∼ 𝒩 ( 0 , I )} [ - \frac{d λ}{dt} {‖ {\hat{ϵ}}_{θ} ( {z}_{t} ; {λ}_{t} ) - ϵ ‖}_{2}^{2} ] .$$

The three weighting functions were compared in both a lower-resolution and a higher-resolution condition. In both experimental conditions, weighting functions of the present disclosure had better inception scores and better FID scores than the prior v-prediction model. A table of example results is provided below:

| | | FID Score | IS score |
|---|---|---|---|
| Resolution | Weighting Function | (lower is better) | (higher is better) |
| 64 × 64 | Prior ν-prediction: | 1.62 | 58.0 +/− 1.56 |
| | exp(−λ/2) | | |
| 64 × 64 | sigmoid(−λ + 2) | 1.51 | 64.4 +/− 1.28 |
| 64 × 64 | Modified EDM- | 1.45 | 64.6 +/− 1.35 |
| | monotonic | | |
| 128 × 128 | Prior ν-prediction: | 1.91 | 171.9 +/− 2.46 |
| | exp(−λ/2) | | |
| 128 × 128 | sigmoid(−λ + 2) | 1.91 | 183.1 +/− 2.20 |
| 128 × 128 | Modified EDM- | 1.75 | 171.1 +/− 2.67 |
| | monotonic | | |

In another example experiment, a monotonic modified EDM weighting of the present disclosure was compared to published results associated with three resolution levels associated with high-resolution image generation. The experiments were performed in a with-guidance condition, wherein the training was combined with classifier-free guidance, and a without-guidance condition. In both conditions, the weighting function of the present disclosure was associated with better FID scores and inception scores than prior methods trained on similar-sized datasets. (At one resolution, two models trained on much larger datasets slightly outperformed systems and methods of the present disclosure.) Example results are provided in a table below. In each experimental condition, the prior model achieving the best published FID score was SimpleDiffusion (U-Net), and the prior model achieving the best IS score was SimpleDiffusion (U-ViT, L). Both of the SimpleDiffusion models are presented by Hoogeboom et al in Simple Diffusion: End-to-end diffusion for high-resolution images (2023), available at https://arxiv.org/abs/2301.11093.

| | | |
|---|---|---|
| Weighting | FID Score | IS score |
| function | (lower is better) | (higher is better) |

Resolution: 128 × 128

| | | |
|---|---|---|
| Best published FID | 2.88 | 137.3 +/− 2.0 |
| Best published IS | 3.23 | 171.9 +/− 2.5 |
| sigmoid (−λ + 2) | 3.41 | 183.1 +/− 2.2 |
| Modified EDM- | 2.88 | 171.1 +/− 2.7 |
| monotonic | | |

Resolution: 256 × 256

| | | |
|---|---|---|
| Best published FID | 3.71 | 171.6 +/− 3.1 |
| Best published IS | 3.75 | 211.8 +/− 2.9 |
| Modified EDM- | 3.36 | 225.3 +/− 3.2 |
| monotonic | | |

Resolution: 512 × 512

| | | |
|---|---|---|
| Best published FID | 4.28 | 171.0 +/− 3.0 |
| Best published IS | 4.53 | 205.3 +/− 2.7 |
| Modified EDM- | 3.36 | 232.2 +/− 4.2 |
| monotonic | | |

Additionally, in some example experiments according to the present disclosure, adaptive noise distributions of the present disclosure were compared to prior fixed noise distributions.

In one example experiment according to the present disclosure, an adaptive noise distribution of the present disclosure was compared to a prior EDM noise distribution associated with an EDM model, using a same weighting function. A prior EDM weighting function was used in both conditions. The adaptive noise distribution of the present disclosure was associated with a slightly better FID score (1.43 vs. 1.45) and inception score (63.2 vs. 60.7). Additionally, the adaptive noise distribution of the present disclosure was associated with a significantly faster convergence than the prior EDM noise distribution. Thus, it will be appreciated that adaptive noise distributions of the present disclosure can in some instances lead to improved convergence properties compared to prior noise distributions, with no negative impact on final training outcomes (e.g., FID scores, inception scores, etc.).

In another example experiment according to the present disclosure, a fixed cosine noise distribution associated with a ϵ-prediction model was compared to an adaptive noise distribution according to the present disclosure, using a same weighting function. For both noise distributions, a sigmoid(−λ+2) weighting function of the present disclosure was used. The experiment was performed under two sampler conditions: a DDPM sampler and an EDM sampler. In the example experiment, adaptive noise distributions of the present disclosure had no net impact on average FID scores across the two experimental conditions (0.02 better than a fixed noise distribution for EDM sampler, 0.02 worse than for DDPM sampler). Additionally, adaptive noise distributions of the present disclosure converged at approximately the same rate as the prior fixed cosine noise distribution. Thus, it will be appreciated that adaptive noise distributions of the present disclosure can in some instances lead to convergence properties that are similar to prior fixed noise distributions that have been well-tuned for a particular weighting function (e.g., via labor-intensive hand-tuning), with no negative impact on final training outcomes. Thus, it will be appreciated that adaptive noise distributions of the present disclosure can in some instances facilitate more efficient (e.g., lower computational cost, lower labor cost, etc.) searching of a weighting function search space, by enabling more efficient testing of untested weighting functions, for which a well-tuned fixed noise distribution has not been identified.

### Example Methods

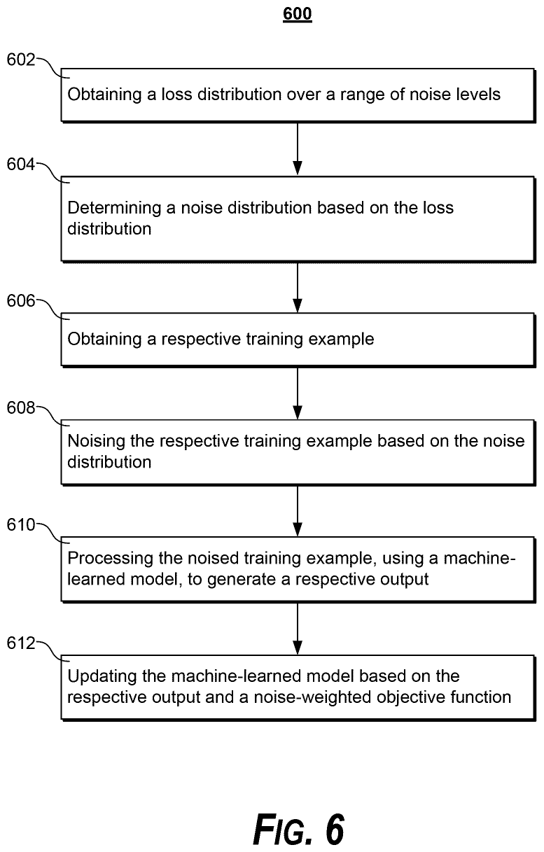

FIG. 6 is a flow chart diagram illustrating an example method 600 for training a machine-learned model according to example embodiments of the present disclosure. Example method 600 can be implemented by one or more computing systems (e.g., one or more computing systems as discussed with respect to FIGS. 1 to 15). Although FIG. 6 depicts steps performed in a particular order for purposes of illustration and discussion, the methods of the present disclosure are not limited to the particularly illustrated order or arrangement. The various steps of example method 600 can be omitted, rearranged, combined, and/or adapted in various ways without deviating from the scope of the present disclosure.

At 602, example method 600 can include obtaining a loss distribution over a range of noise levels. In some instances, the loss distribution can describe loss magnitudes computed using outputs of a reference machine-learned image processing model when processing training images that were noised using the range of noise levels. In some instances, the loss distribution can comprise a plurality of respective aggregated values associated with a plurality of respective subranges of the range of noise levels. In some instances, a respective aggregated value can comprise an exponential moving average. In some instances, the loss distribution can be configured to have an expected value that is stable with respect to a change, other than a change to one or more endpoints, of a noise distribution as described below at 604. In some instances, a loss distribution can be, comprise, or be comprised by a loss distribution 504. In some instances, method 600 can include, at 602, using one or more systems or components described with respect to FIG. 5, or performing one or more activities described with respect to FIG. 5.

At 604, example method 600 can include determining a noise distribution based on the loss distribution. In some instances, a noise distribution can be, comprise, or be comprised by a piecewise noise distribution 506 or noise distribution 112. In some instances, the noise distribution can be configured to decrease a variance of loss values generated by the loss function during training. In some instances, determining the noise distribution can comprise determining, based on a plurality of respective aggregated values as described at 602, a plurality of respective noise probabilities associated with a plurality of respective subranges as described at 602, wherein a respective noise probability can be proportional to a corresponding respective aggregated value. In some instances, method 600 can include, at 604, using one or more systems or components described with respect to FIG. 5, or performing one or more activities described with respect to FIG. 5.

At 606, example method 600 can include obtaining a respective training example. In some instances, a respective training example can be, comprise, or be comprised by a training image 104. In some instances, method 600 can include, at 606, using one or more systems or components described with respect to FIGS. 1, 2, and 4, or performing one or more activities described with respect to FIGS. 1, 2, and 4.

At 608, example method 600 can include noising the respective training example based on the noise distribution. In some instances, the noise distribution can be characterized by a range of noise levels, which can in some instances be the same as the range of noise levels described at 602. In some instances, noising the respective training example can be, comprise, or be comprised by generating a noised training image 114. In some instances, method 600 can include, at 608, using one or more systems or components described with respect to FIGS. 1, 2, and 4, or performing one or more activities described with respect to FIGS. 1, 2, and 4.

At 610, example method 600 can include processing the noised training example, using a subject machine-learned model, to generate a respective output. In some instances, a subject machine-learned model can be, comprise, or be comprised by a machine-learned model 116. In some instances, the subject machine-learned model can be the same as or different from the reference machine-learned model described at 602. In some instances, the loss distribution described at 602 can be a loss distribution obtained during training of the subject machine-learned model. In some instances, an output can be, comprise, or be comprised by an output 118. In some instances, method 600 can include, at 610, using one or more systems or components described with respect to FIGS. 1, 2, and 4, or performing one or more activities described with respect to FIGS. 1, 2, and 4.

At 612, example method 600 can include updating the machine-learned model based on the respective output and a noise-weighted objective function. In some instances, the noise-weighted objective function can be characterized by a weighting function that is monotonically non-increasing with a measure of signal-to-noise ratio. In some instances, the weighting function can be characterized by a plateau having a first average slope over a first subrange of noise levels, and a descent having a second average slope over a second subrange of noise levels. In some instances, the first subrange of noise levels can contain at least one noise level lower than at least one noise level of the second subrange. In some instances, the second average slope can be steeper than the first average slope. In some instances, the weighting function can be characterized by a maximum weight over the range of noise levels. In some instances, at least one weight associated with a log-signal-to-noise ratio between −2.5 and 2.5 can be greater than or equal to 20 percent of the maximum weight. In some instances, updating the machine-learned model can be, comprise, or be comprised by a model update 124. In some instances, the weighting function can be characterized by a finite maximum weight over its natural domain.

In some instances, the weighting function can be characterized by an overall minimum weight and overall maximum weight over the range of noise levels. In some instances, the weighting function can be characterized by a subrange maximum weight and subrange minimum weight over the second subrange of noise levels. In some instances, a difference between the subrange maximum weight and the subrange minimum weight can be at least 70 percent of a difference between the overall maximum weight and the overall minimum weight.

In some instances, the weighting function can be characterized by one or more steepest points, wherein a slope of the weighting function at the steepest points is steeper than a slope of the weighting function at any other point. In some instances, at least one of the steepest points can be associated with a log-signal-to-noise ratio between 5.0 and −5.0.

In some instances, the weighting function can correspond to a noise weighting of an evidence lower bound. In some instances, updating the machine-learned model can include optimizing the machine-learned model with respect to a monotonically noise-weighted evidence lower bound. In some instances, the machine-learned model can be a first machine-learned model, and example method 600 can further include optimizing a second machine-learned model with respect to the monotonically noise-weighted evidence lower bound. In some instances, the first machine-learned model can be a diffusion model. In some instances, the second machine-learned model can be a model that is not a diffusion model. In some instances, the second machine-learned model can be a likelihood-based machine-learned model.

In some instances, method 600 can include, at 612, using one or more systems or components described with respect to FIGS. 1, 2, and 4, or performing one or more activities described with respect to FIGS. 1, 2, and 4.

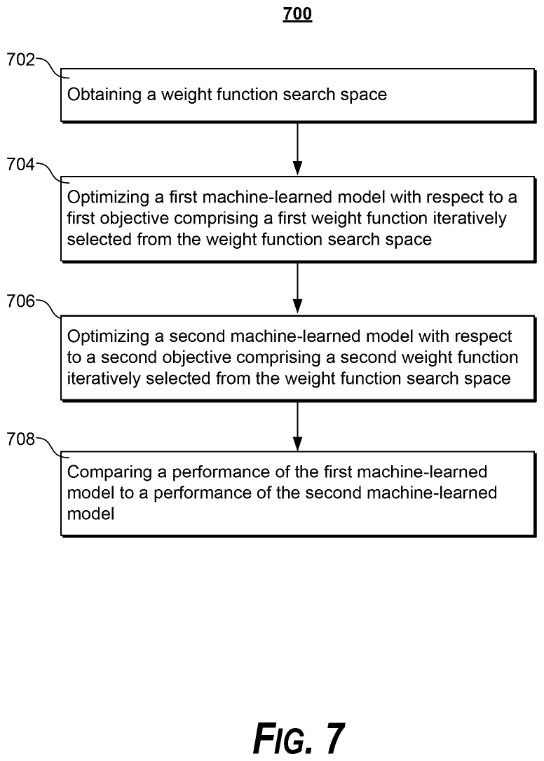

FIG. 7 is a flow chart diagram illustrating an example method 700 for comparing weighting functions of a weight function search space according to example embodiments of the present disclosure. Example method 700 can be implemented by one or more computing systems (e.g., one or more computing systems as discussed with respect to FIGS. 1 to 15). Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include obtaining a weight function search space. In some instances, the weight function search space can be, comprise, or be comprised by one or more weighting functions 300. In some instances, the weighting function can comprise a parameterized function. In some instances, iteratively selecting a weight function from the weight function search space can comprise updating a parameter of the parameterized function. In some instances, method 700 can include, at 702, using one or more systems or components described with respect to FIG. 3, or performing one or more activities described with respect to FIG. 3.

At 704, example method 700 can include optimizing a first machine-learned model with respect to a first objective comprising a first weight function iteratively selected from the weight function search space. In some instances, the first weight function can be a function of noise level. In some instances, the first objective can correspond to a monotonically noise-weighted evidence lower bound. In some instances, the first machine-learned model can be, comprise, or be comprised by a machine-learned model 116. In some instances, method 700 can include, at 704, using one or more systems or components described with respect to FIG. 3, or performing one or more activities described with respect to FIG. 3.

At 706, example method 700 can include optimizing a second machine-learned model with respect to a second objective comprising a second weight function iteratively selected from the weight function search space. In some instances, the second machine-learned model can be, comprise, or be comprised by a machine-learned model 116. In some instances, method 700 can include, at 706, using one or more systems or components described with respect to FIG. 3, or performing one or more activities described with respect to FIG. 3.

At 708, example method 700 can include comparing a performance of the first machine-learned model to a performance of the second machine-learned model. In some instances, method 700 can include, at 708, using one or more systems or components described with respect to FIG. 3, or performing one or more activities described with respect to FIG. 3.

In some instances, example method 700 can further include obtaining a loss distribution over a range of noise levels. In some instances, the loss distribution can describe loss magnitudes computed using outputs of a reference machine-learned image processing model when processing training images that were noised using the range of noise levels. In some instances, example method 700 can further include determining, based on the loss distribution, a noise distribution. In some instances, optimizing the second machine-learned model can include training, using a loss function, the second machine-learned model using noised training images that were noised using noise levels selected according to the noise distribution. In some instances, the noise distribution can be configured to decrease a variance of loss values generated by the loss function during training.

FIG. 8 depicts a flowchart of a method 800 for training one or more machine-learned models according to aspects of the present disclosure. For instance, an example machine-learned model can include a machine-learned model 116.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc. In some instances, machine-learned model(s) 1 can be or include machine-learned models 116.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema. In some instances, inputs 2 can be or include noised training images 114, and outputs 3 can be or include outputs 118.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Model Development Platform

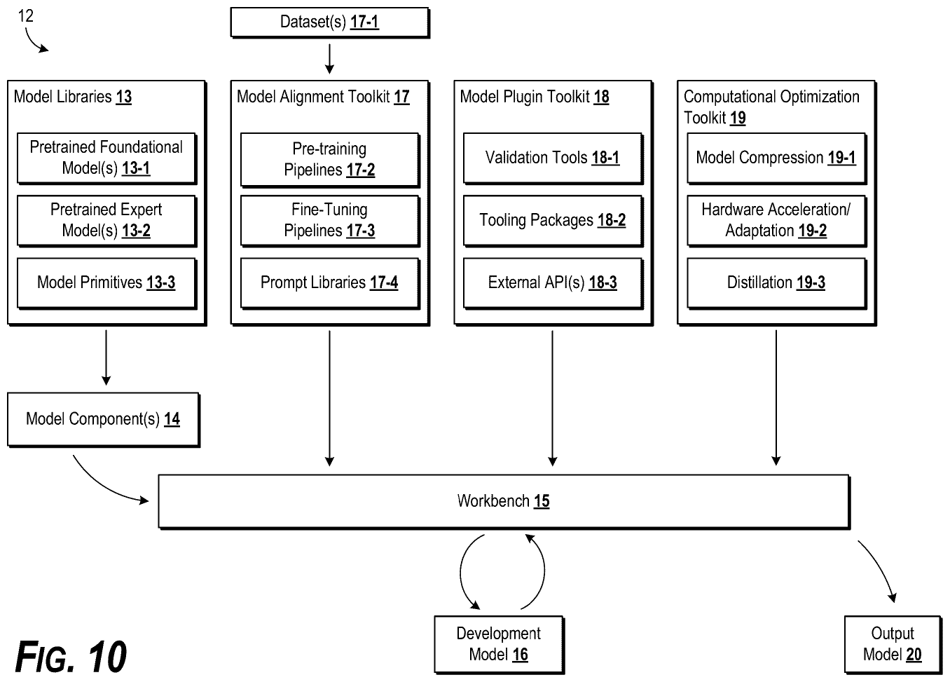

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

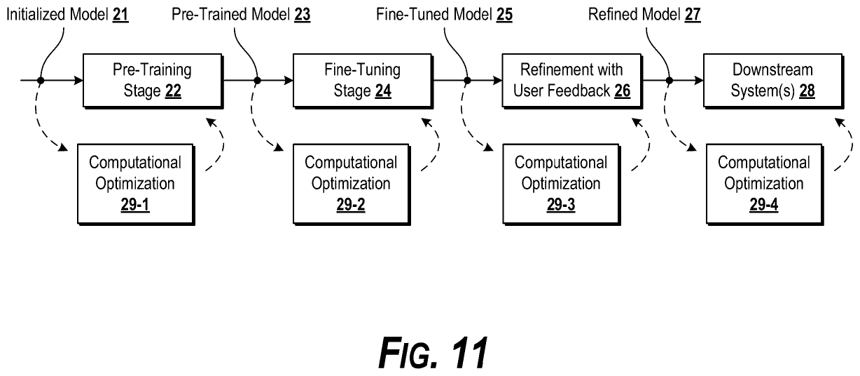

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

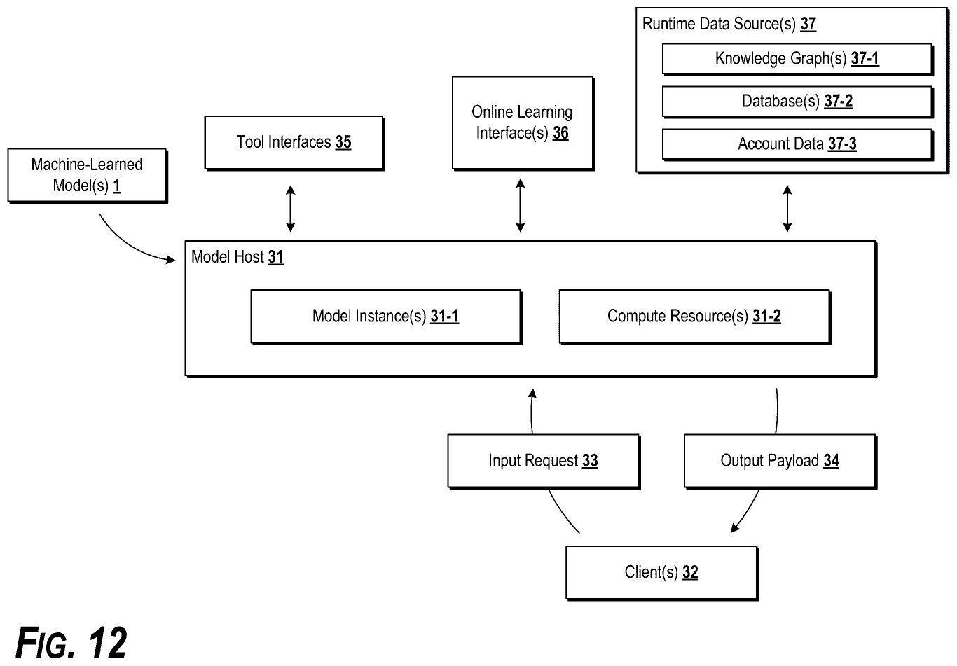

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

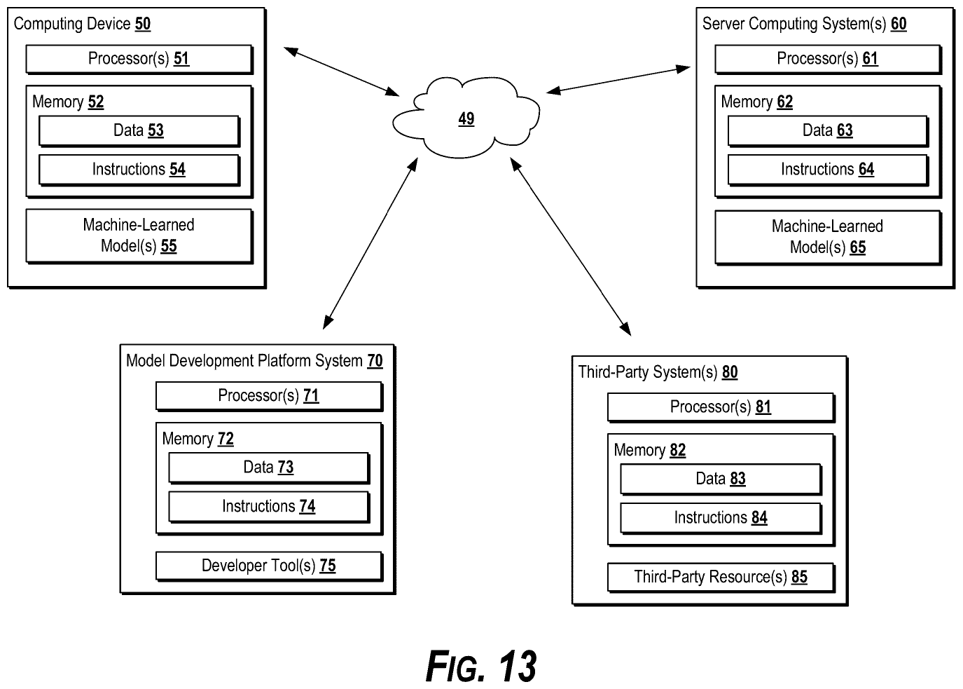

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.). In some instances, a computing device 50 or server computing system 60 can be, comprise, or implement a training system 102, sampler 108, or noise distribution updater 402.

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

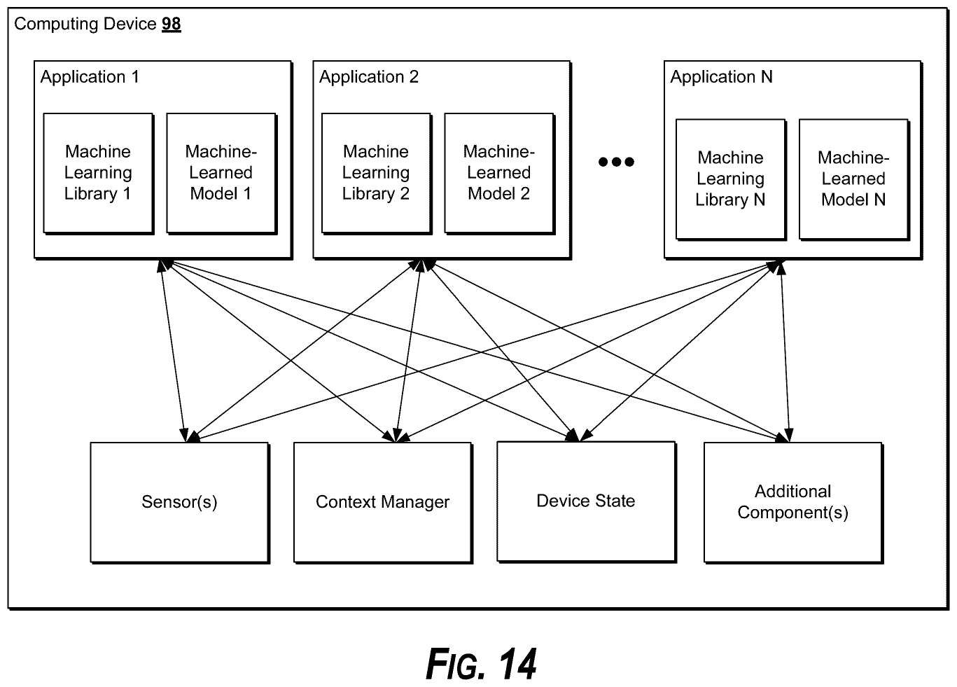

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

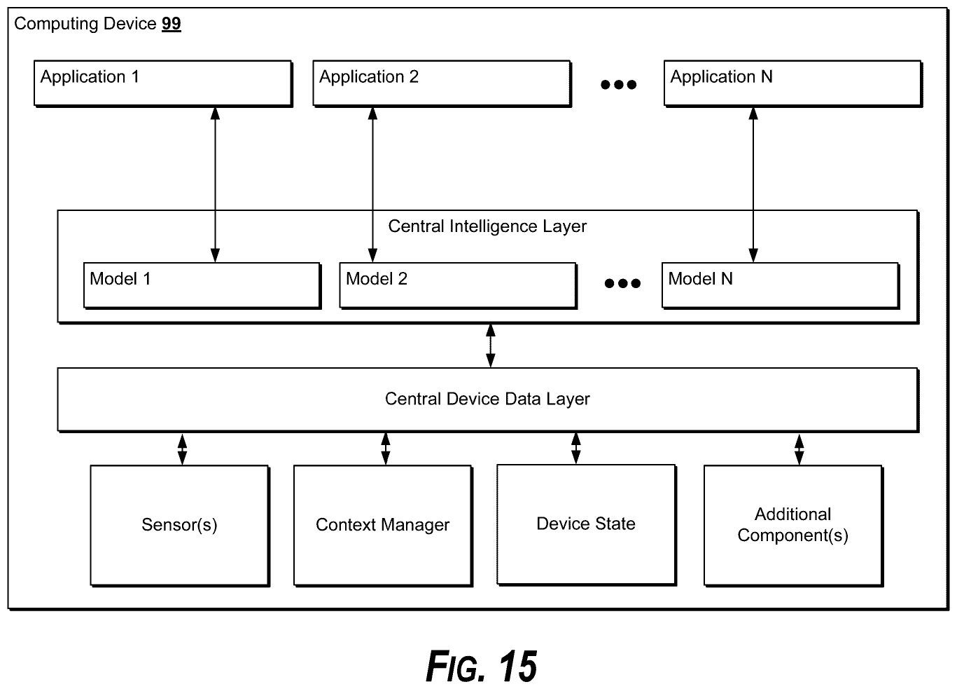

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for training a machine-learned image processing model using an adaptive noise schedule, comprising:
obtaining a loss distribution over a range of noise levels, wherein the loss distribution describes loss magnitudes computed using outputs of a reference machine-learned image processing model when processing training images that were noised using the range of noise levels;
determining, based on the loss distribution, a noise distribution; and
training, using a loss function, a subject machine-learned image processing model using noised training images that were noised using noise levels selected according to the noise distribution;
wherein the noise distribution is configured to decrease a variance of loss values generated by the loss function during training.

2. The method of claim 1, wherein the reference machine-learned image processing model is the subject machine-learned image processing model and the loss distribution is obtained during training of the subject machine-learned image processing model.

3. The method of claim 1, wherein the loss distribution comprises a plurality of respective aggregated values associated with a plurality of respective subranges of the range of noise levels.

4. The method of claim 3, wherein a respective aggregated value of the plurality of respective aggregated values comprises an exponential moving average.

5. The method of claim 3, wherein determining the noise distribution comprises determining, based on the plurality of respective aggregated values, a plurality of respective noise probabilities associated with the plurality of respective subranges, wherein a respective noise probability is proportional to a corresponding respective aggregated value.

6. The method of claim 1, wherein the loss function is configured to have an expected value that is stable with respect to a change, other than a change to one or more endpoints, to the noise distribution.

7. A computer-implemented method for training a machine-learned model using an improved weighting function, comprising:
obtaining a respective training example;
noising the respective training example based on a noise distribution characterized by a range of noise levels;
processing the noised training example to generate a respective output; and
updating the machine-learned model based on the respective output and a noise-weighted objective function, wherein:
the noise-weighted objective function is characterized by a weighting function that is monotonically non-increasing with a measure of signal-to-noise ratio; and
the weighting function is characterized by a plateau having a first average slope over a first subrange of noise levels, and a descent having a second average slope over a second subrange of noise levels, wherein:
the first subrange of noise levels contains at least one noise level lower than at least one noise level of the second subrange; and
the second average slope is steeper than the first average slope.

8. The method of claim 7, wherein:
the weighting function is characterized by a maximum weight over the range of noise levels; and
at least one weight associated with a log-signal-to-noise ratio between −2.5 and 2.5 is greater than or equal to 20 percent of the maximum weight.

9. The method of claim 7, wherein the weighting function is characterized by a finite maximum weight over its natural domain.

10. The method of claim 7, wherein:
the weighting function is characterized by an overall minimum weight and overall maximum weight over the range of noise levels;
the weighting function is characterized by a subrange maximum weight and subrange minimum weight over the second subrange of noise levels; and
a difference between the subrange maximum weight and the subrange minimum weight is at least 70 percent of a difference between the overall maximum weight and the overall minimum weight.

11. The method of claim 7, wherein:
the weighting function is characterized by one or more steepest points, wherein a slope of the weighting function at the steepest points is steeper than a slope of the weighting function at any other point within the range of noise levels; and
none of the steepest points is an endpoint of the range of noise levels.

12. The method of claim 7, wherein:
the weighting function is characterized by one or more steepest points, wherein a slope of the weighting function at the steepest points is steeper than a slope of the weighting function at any other point; and
at least one of the steepest points is associated with a log-signal-to-noise ratio between 5.0 and −5.0.

13. The method of claim 7, wherein the weighting function corresponds to a noise weighting of an evidence lower bound.

14. The method of claim 7, wherein:
updating the machine-learned model comprises optimizing the machine-learned model with respect to a monotonically noise-weighted evidence lower bound;
the machine-learned model is a first machine-learned model;
and further comprising:
optimizing a second machine-learned model with respect to the monotonically noise-weighted evidence lower bound;
wherein the first machine-learned model is a diffusion model; and
the second machine-learned model is not a diffusion model.

15. The method of claim 14, wherein the second machine-learned model is a likelihood-based machine-learned model.

16. A computer-implemented method for searching for an optimized weight function over a weight function search space, comprising:
obtaining a weight function search space;
optimizing a first machine-learned model with respect to a first objective comprising a first weight function iteratively selected from the weight function search space;
optimizing a second machine-learned model with respect to a second objective comprising a second weight function iteratively selected from the weight function search space; and
comparing a performance of the first machine-learned model to a performance of the second machine-learned model.

17. The method of claim 16, wherein:
the weight function search space comprises a parameterized function; and
iteratively selecting a weight function from the weight function search space comprises updating a parameter of the parameterized function.

18. The method of claim 16, further comprising:
obtaining a loss distribution over a range of noise levels, wherein the loss distribution describes loss magnitudes computed using outputs of a reference machine-learned image processing model when processing training images that were noised using the range of noise levels; and
determining, based on the loss distribution, a noise distribution; and wherein:
optimizing the second machine-learned model comprises training, using a loss function, the second machine-learned model using noised training images that were noised using noise levels selected according to the noise distribution; and
the noise distribution is configured to decrease a variance of loss values generated by the loss function during training.

19. The method of claim 16, wherein the first weight function is a function of a noise level.

20. The method of claim 16, wherein the first objective corresponds to a monotonically noise-weighted evidence lower bound.
